(19) United States
(12) Patent Application Publication
(10) Pub. No.: US 2005/0127813 A1
(43) Pub. Date: Jun. 16, 2005

(54) Surface conduction type electron-emitting display device and manufacturing method thereof

(75) Inventor: Seong-Hak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/007,175

(22) Filed: Dec. 9, 2004

(30) Foreign Application Priority Data
Dec. 11, 2003 (KR) 90259/2003

(51) Int. Cl. H01J 1/62; H01J 63/04

(52) U.S. Cl. 313/495

(57) ABSTRACT

A surface conduction type electron-emitting display device and its manufacturing method capable of performing self-focusing so that electrons tunneled between a scan electrode and a data electrode do not spread is disclosed. A round groove is formed at a predetermined region of a lower substrate where a cell is formed so that tunneled electrons do not spread and have a curved line locus. Accordingly, electron beam distortion is prevented, and brightness and efficiency can be improved.

### BACKGROUND OF THE INVENTION

1. Field of the Invention

The present invention relates to a surface conduction type electron-emitting display device, and particularly, to a surface conduction type electron-emitting display device for self-focusing and its manufacturing method capable of preventing distortion of an electron beam in tunneling and obtaining high brightness by forming a round groove at a predetermined region of a lower substrate where a cell is formed.

2. Description of the Background Art

A field emission display device is receiving much attention as a flat panel display device for next generation information communications, which overcomes all of disadvantages of flat panel display devices (such as LCDs, PDPs, VFDs and the like) being currently developed or manufactured. Such a field emission display device has advantages that a display device should have, such as a simple electrode structure, a high-speed operation like a CRT, infinite colors, an infinite gray scale, a high brightness, a high video rate and the like.

FIG. 1 is a sectional view showing a structure of a tip type field emission display device in accordance with the conventional art.

As shown, the tip type field emission display device includes: a cathode electrode 2 and a gate electrode 4 formed on a lower glass substrate 1 and receiving a predetermined electric field; an insulation layer 3 for electrically insulating the cathode electrode 2 and the gate electrode 4 from each other; an emitter 5 for emitting electrons (e) by the electric field applied to the cathode electrode 2 and the gate electrode 4; an anode electrode 8 formed on an upper glass substrate 9 and receiving a high voltage for allowing the electrons emitted from the emitter 5 to have directionality; a fluorescent body 7 emitting light by colliding with the emitted electron beam; and a spacer 6 for supporting an upper substrate 10 and a lower substrate 11.

As described above, the emitter 5 formed in the micro tip structure has an excellent electron emitting characteristic. However, in order to make a large-scale display device of 20 inches or greater using the emitter 5, a large amount of equipment investment is required, and its manufacturing process becomes complicated, thereby greatly lowering competitiveness of a product in comparison with other display devices.

Recently, in order to solve such problems, a surface conduction type electron-emitting display (SED) device is used. Such a surface conduction type electron emitting display device generally has a simple manufacturing process and structure, and can be manufactured in a large size without big difficulties.

FIG. 2 shows an embodiment of a simple matrix structure of a conventional surface conduction type electron-emitting device.

As shown, as for the conventional surface conduction type electron-emitting device, a plurality of scan electrodes (or cathode electrodes) (Scan 1˜Scan n) 20 and a plurality of data electrodes (or gate electrodes) (D₁˜Dₘ) 30 intersect at right angles, and cells are formed at predetermined regions formed by such intersection. For example, a cell (Cell) is formed above the scan electrode 20 and on the left of the data electrode 30. Accordingly, the cells are arranged in a sequential order of R, G and B from the left toward the right.

FIG. 3 is a sectional view showing a cell of the conventional surface conduction type electron-emitting display device depicted in FIG. 2.

As shown, in the surface conduction type electron-emitting display device, an emitter gap 41 is formed on the part of a conductive thin film 40 through a forming process of applying a DC high voltage to both ends of the conductive thin film 40. Thereafter, if a predetermined voltage is applied to both ends of the emitter gap 41 (namely, to a scan electrode 20 and a data electrode 30), a high electric field is applied at the emitter gap 41, so that electron (e) emission is made. At this time, the electrons (e) emitted from the emitter gap 41 perform tunneling along a surface of the conductive thin film 40 and are accelerated by a high voltage applied to an anode electrode 60, thereby colliding with the fluorescent body 50. Accordingly, the fluorescent body 50 is excited by the energy generated by the collision, thereby performing light emission.

However, the conventional surface conduction type electron emitting display device is disadvantageous in that emission of electrons is made lopsided because of a plane shape of a lower substrate 70 region where a cell is formed, and thus an electron beam spreads widely.

FIG. 4 is an exemplary view showing a locus of an electron beam emitted from a cell of the conventional surface conduction type electron-emitting display device.

As shown, in the surface conduction type electron-emission display device, because electrons emitted from the emitter 40 are moved toward the data electrode (D) and then accelerated toward the anode electrode 60, the emitted electrons perform light emission lopsided to one portion of an R fluorescent body 51. Namely, the conventional surface conduction type electron-emitting display device is disadvantageous in that a surface of the fluorescent body cannot be entirely used because of electrons emitted outside a region, a cross talk or a spacer charge occurs because the electron beam emitted from the emitter 40 gets bent to a wide extent and thus invades a neighboring cell. Accordingly, the conventional surface conduction type electron emitting display device disadvantageously has degraded brightness and efficiency.

### SUMMARY OF THE INVENTION

Therefore, an object of the present invention is to provide a surface conduction type electron emitting display device for self focusing and its manufacturing method capable of preventing distortion of an electron beam and allowing tunneled electrons to have a curved line locus which does not spread by forming a round groove at a predetermined region of a lower substrate on which a cell is formed through etching and by generating tunneling of electrons inside the groove.

To achieve these and other advantages and in accordance with the purpose of the present invention, as embodied and broadly described herein, there is provided a surface conduction type electron-emitting display device comprising: a lower substrate for self-focusing having a groove at a region where a cell is formed to thereby generate tunneling of electrons inside the groove; and a scan electrode and a data electrode formed on the same plane on the lower substrate and receiving a driving voltage.

To achieve these and other advantages and in accordance with the purpose of the present invention, as embodied and broadly described herein, there is provided a method for manufacturing a surface conduction type electron-emitting display device comprising: forming a cell at a region where a scan electrode and a data electrode meet at a right angle; forming a groove for self-focusing having a predetermined width and depth at a lower substrate region where the cell is formed; and forming a conductive thin film on the scan electrode and the data electrode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a sectional view showing a structure of a conventional tip type field emission display device;

FIG. 2 shows an embodiment of a simple matrix structure of a conventional surface conduction type electron-emitting display device;

FIG. 3 is a sectional view showing a cell of the conventional surface conduction type electron-emitting display device depicted in FIG. 2;

FIG. 4 is an exemplary view showing a locus of an electron beam emitted from a cell of the conventional surface conduction type electron-emitting display device;

FIG. 5 shows an embodiment of a matrix structure of a surface conduction type electron-emitting display device in accordance with an embodiment of the present invention;

FIG. 6 is a sectional view showing a groove structure formed on a lower substrate of the surface conduction type electron-emitting display device in accordance with an embodiment of the present invention;

FIG. 7 is a flow chart showing a method for manufacturing a surface conduction type electron-emitting display device in accordance with an embodiment of the present invention; and

FIG. 8 shows a locus of an electron beam emitted to an R fluorescent body from the surface conduction type electron-emitting display device in accordance with an embodiment of the present invention and a locus of an electron beam emitted from the conventional display device, which is compared to the display device in accordance with the present invention.

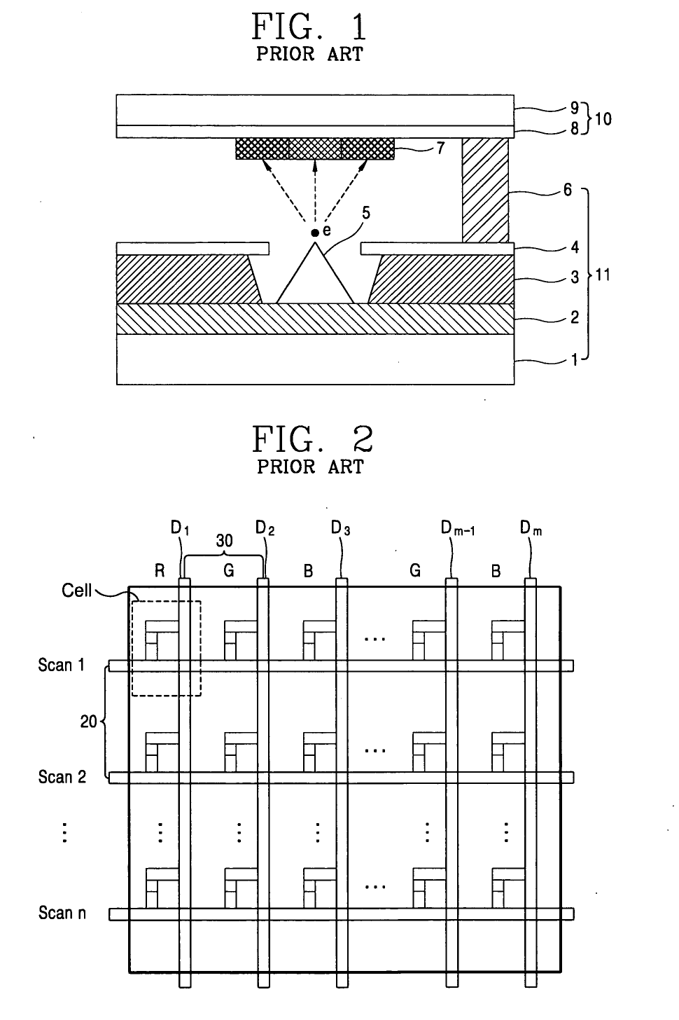

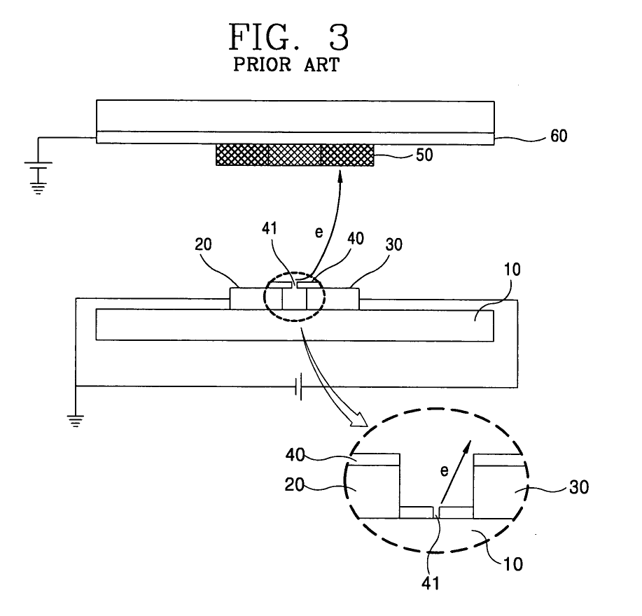

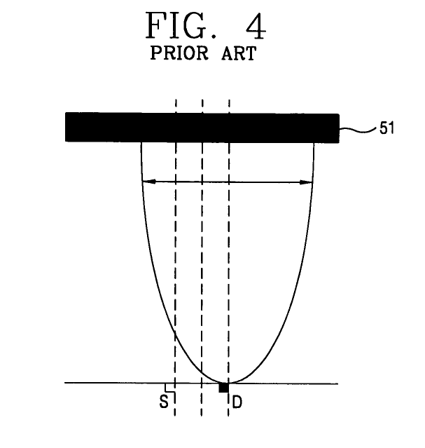

### DETAILED DESCRIPTION OF THE PREFERRED EMBODIMENTS

Reference will now be made in detail to the preferred embodiments of the present invention, examples of which are illustrated in the accompanying drawings.

A preferred embodiment of a surface conduction type electron-emitting display device capable of improving brightness and efficiency by forming a round groove at a predetermined region where a cell is formed, of a lower substrate so that an electron tunneled between a scan electrode and a data electrode does not spread and a self-focusing can be performed, will now be described with reference to accompanying drawings.

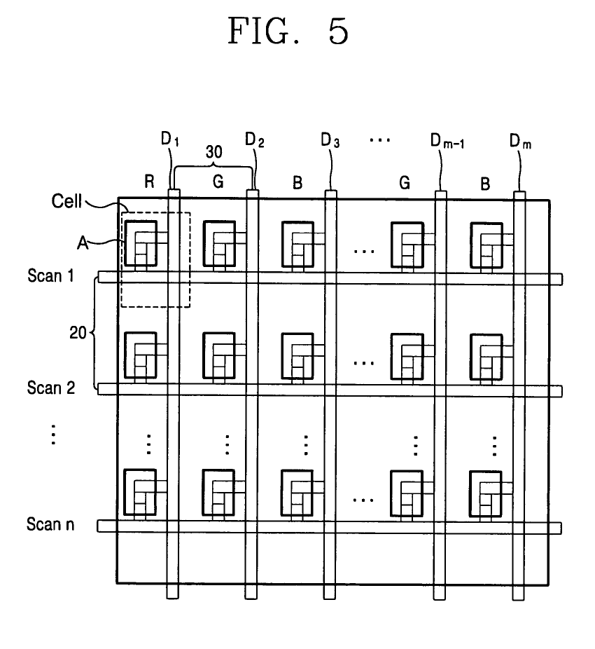

FIG. 5 is an embodiment of a matrix structure of a surface conduction type electron-emitting display device in accordance with an embodiment of the present invention.

As shown, in the surface conduction type electron-emitting display device in accordance with an embodiment of the present invention, a plurality of scan electrodes (Scan 1˜Scan n) 20 and a plurality of data electrodes (D₁˜Dₘ) 30 intersect at right angles as a matrix type, and each cell (Cell) is formed at a predetermined region formed by such intersection. A groove (A) with a predetermined width and depth is formed at a predetermined region where the cell is formed, of a lower substrate. At this time, a portion where the scan electrode 20 and the data electrode 30 meet at a right angle is insulated by an insulator, and a fluorescent body (not shown) formed on an upper substrate (not shown) may have any of a stripe structure, a delta structure and the like.

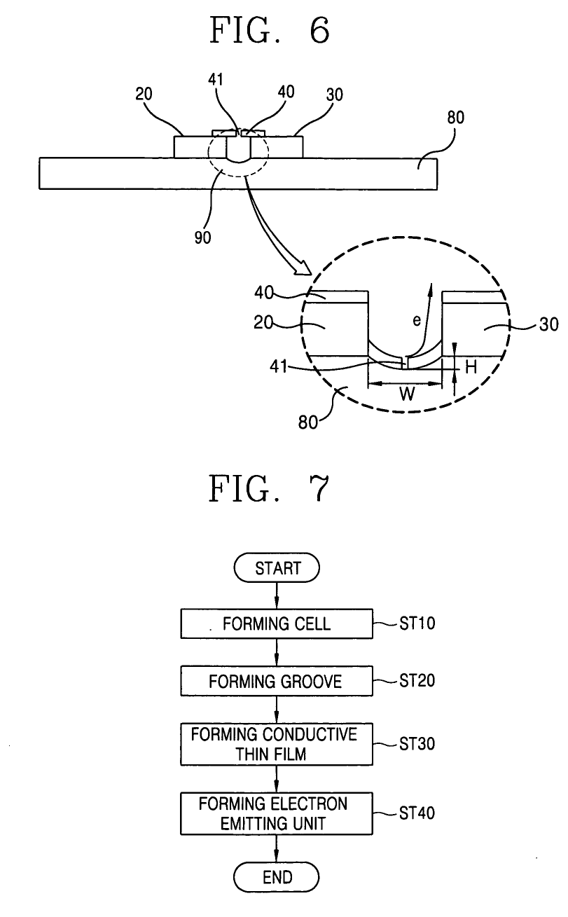

FIG. 6 is a sectional view showing a structure of a groove formed on a lower substrate of a surface conduction type electron-emitting display device in accordance with an embodiment of the present invention.

As shown, the surface conduction type electron-emitting display device in accordance with the present invention includes: a lower substrate 80 having a round groove with a predetermined width (W) and depth (H) at a region where a cell is formed and performing a self-focusing function for an emitted electron beam; a scan electrode 20 and a data electrode 30 formed on the same plane on the lower substrate 80 and receiving a driving voltage; an electron emitting unit 90 having a conductive thin film (i.e., an emitter) on the scan electrode 20 and the data electrode 30 and an emitter gap 41 formed through a forming process of applying a DC voltage to the conductive thin film.

FIG. 7 is a flow chart showing a method for manufacturing a surface conduction type electron-emitting display device in accordance with an embodiment the present invention.

As shown, the method for manufacturing the surface conduction type electron-emitting display device includes: a step of forming a cell at a region where a scan electrode 20 and a data electrode 30 meet at a right angle (ST10); a step of forming a groove with a predetermined width and depth at a lower substrate region where the cell is formed (ST20); a step of forming a conductive thin film 40 on the scan electrode and the data electrode (ST30); and an electron emitting unit forming step of forming an emitter gap 41 by performing a forming process on both ends of the formed conductive thin film 40 (ST40).

The groove formed on the lower substrate 80 is a round groove (A) formed through etching or the like, and a width (W) of the formed groove is 10˜20 μm, and its height (H) is 1 μm or smaller. In addition, the conduction thin film 40 is metal oxide formed with a certain thickness through a printing process and preferably contains a PdO constituent. Also, the electron emitting unit 90 is made to be in a electrically high resistance state by applying a constant DC voltage or a uniformly boosted DC voltage to the conductive thin film and thus locally destroying the conductive thin film.

Accordingly, in the surface conduction type electron-emitting display device in accordance with the present invention, tunneling of electrons is made inside the groove of the lower substrate 80, and the tunneled electrons (e) are bent as a shape of the groove inside the cell to be emitted. Namely, because a locus of an electron beam is varied according to a depth (H) of the groove and a width (W) between the electrodes of the cell, the locus of the emitted electron beam may be freely controlled by controlling the depth (H) of the groove and the width (W) between the electrodes.

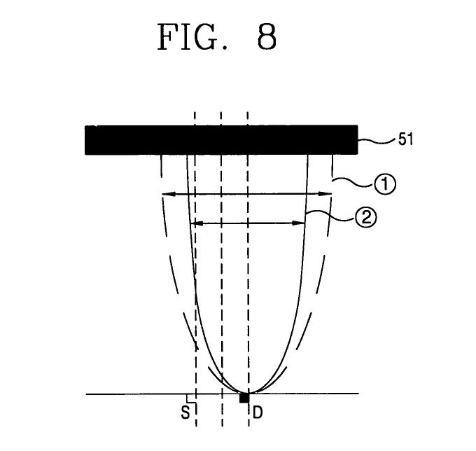

FIG. 8 shows a locus of an electron beam emitted to an R fluorescent body in the surface conduction type electron emitting display device in accordance with an embodiment of the present invention and a locus of an electron beam emitted in the conventional display device compared to the present one.

As shown, the locus (\mathring{2}) of the electron beam formed by the present invention is on the inward side as compared to a locus (\mathring{1}) of an electron beam formed by the conventional display device. Accordingly, even if an interval between an anode electrode (not shown) formed on the upper substrate and a cathode part (not shown) including a scan electrode and a data electrode formed on the lower substrate 80 is lengthened, brightness degradation, electron beam distortion and cross talk can be prevented because the electrons are accurately focused on the fluorescent body thus to excite the entire surface of the fluorescent body. In addition, the surface conduction type electron emitting display device can advantageously implement high brightness because a high voltage which is higher than that in the conventional art can be applied by lengthening the interval between the anode electrode and the cathode part. Meanwhile, the locus of the electron beam is lopsided to the data electrode (D), which is affected by polarity of a voltage applied to the scan electrode (S) and the data electrode (D). Thusly, if a voltage having the opposite polarity is applied thereto, the locus of the electron beam is lopsided to the scan electrode (S) by the polarity of the applied voltage.

As so far described in detail, compared to the conventional art in which an electron beam spreading phenomena is severe depending on a driving voltage, an interval between electrodes, a forming condition, a spot where a field is extinguished (disappeared) and a spacer interval, degrading reliability, the present invention is advantageous in that a round groove is formed by etching a region of the lower substrate, corresponding to the cell to thereby generate tunneling inside the groove and to serve as a self-focusing so that tunneled electrons do not widely spread and have a curved line locus. Accordingly, distortion of the electron beams is prevented, the high brightness can be obtained.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A surface conduction type electron-emitting display device comprising:
a lower substrate for self-focusing having a groove at a region where a cell is formed to thereby generate tunneling of electrons inside the groove; and
a scan electrode and a data electrode formed on the same plane on the lower substrate and receiving a driving voltage.

2. The device of claim 1, wherein the groove is formed in a round-shaped and has a predetermined width and depth.

3. The device of claim 2, wherein the width of the groove is 10˜20 μm.

4. The device of claim 2, wherein the depth of the groove is 1 μm or smaller.

5. The device of claim 1, further comprising:
an electron emitting unit having a conductive thin film formed on the scan electrode and the data electrode and an emitter gap formed by performing a forming process on the conductive thin film.

6. The device of claim 5, wherein the conductive thin film is metal oxide formed with a certain thickness through a printing process.

7. The device of claim 6, wherein the metal oxide preferably contains a PdO constituent.

8. The device of claim 1, wherein the scan electrode and the data electrode intersect at a right angle in a matrix type.

9. The device of claim 8, wherein a region where the scan electrode and the data electrode overlap with each other is insulated by an insulator.

10. A method for manufacturing a surface conduction type electron-emitting display device comprising:
forming a cell at a region where a scan electrode and a data electrode meet at a right angle;
forming a groove for self-focusing having a predetermined width and depth at a lower substrate region where the cell is formed; and
forming a conductive thin film on the scan electrode and the data electrode.

11. The method of claim 10, wherein in the step of forming the groove, the groove is formed in a region corresponding to the cell to thereby generate tunneling inside the groove, so that tunneled electrons have a curved line locus.

12. The method of claim 11, wherein the groove is formed as a round groove based on a depth of the groove and a width between electrodes of the cell in order to control an emission locus of an electron beam.

13. The method of claim 11, wherein a width of the groove is 10˜20 μm, and a depth of the groove is 1 μm or smaller.

14. The method of claim 10, wherein a portion where the scan electrode and the data electrode meet at a right angle is insulated by an insulator.

15. The method of claim 10, wherein the conductive thin film is a metal oxide formed with a certain thickness through a printing process and is preferably PdO.

16. The method of claim 10, further comprising:
an electron emitting unit forming step of forming an emitter gap by applying a predetermined DC voltage to both ends of the conductive thin film.

17. The method of claim 16, wherein the electron emitting unit is made to be in an electrically high resistance state by applying a constant DC voltage or a uniformly boosted DC voltage to both ends of the conductive thin film and thus locally destroying the conductive thin film.
